(19) United States
(12) Patent Application Publication
(10) Pub. No.: US 2014/0315414 A1
(43) Pub. Date: Oct. 23, 2014

(54) PLUG TOOL FOR PLUGGING OR UNPLUGGING CONNECTOR

(71) Applicants: Hong Fu Jin Precision Industry (ShenZhen) Co., Ltd., (US); HON HAI PRECISION INDUSTRY CO., LTD., New Taipei (TW)

(72) Inventors: XIA-BING GAO, Shenzhen (CN); AI-LING HE, Shenzhen (CN); HAN-BING ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/873,125

(22) Filed: Apr. 29, 2013

(30) Foreign Application Priority Data
Apr. 17, 2013 (CN) 2013101332635

(51) Int. Cl. H01R 13/629; H01R 43/26; H01R 13/627

(52) U.S. Cl. CPC H01R 13/629; H01R 13/6275; H01R 43/26
USPC 439/352; 29/758

(57) ABSTRACT

A plug tool for plugging or unplugging a connector includes a first operation member and a second operation member. The connector includes a plug, a resilient latching piece, and a cable. The first operation member includes a fastening shell receiving the plug and a sleeve extending out from the fastening shell receiving the cable of the connector. The second operation member is rotatably connected to the sleeve. The second operation member includes a pressing portion for pressing the latching piece of the connector toward the plug.

### BACKGROUND

1. Technical Field

The present disclosure relates to a plug tool for plugging or unplugging a connector.

2. Description of Related Art

For a certain type of switch, a great number of small-sized connectors need to be connected to the switch. However, plugging or unplugging a connector by hand can be difficult and inconvenient because of limited or cramped operation space.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an embodiment of a plug tool together with a switch and a connector.

FIG. 2 is an exploded, enlarged, isometric view of the plug tool and the connector of FIG. 1.

FIG. 3 is an inverted view of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

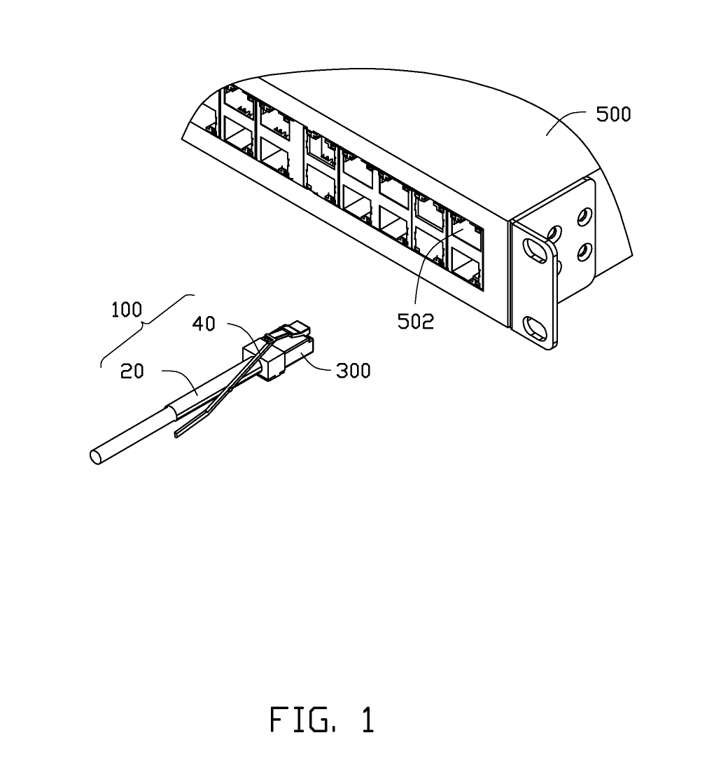

FIG. 1 shows an embodiment of a plug tool 100 used to mount a connector 300. The connector 300 is plugged to a switch 500 or unplugged from the switch 500 with the plug tool 100. The switch 500 includes a plurality of interfaces 502. The plug tool 100 includes a first operation member 20 and a second operation member 40.

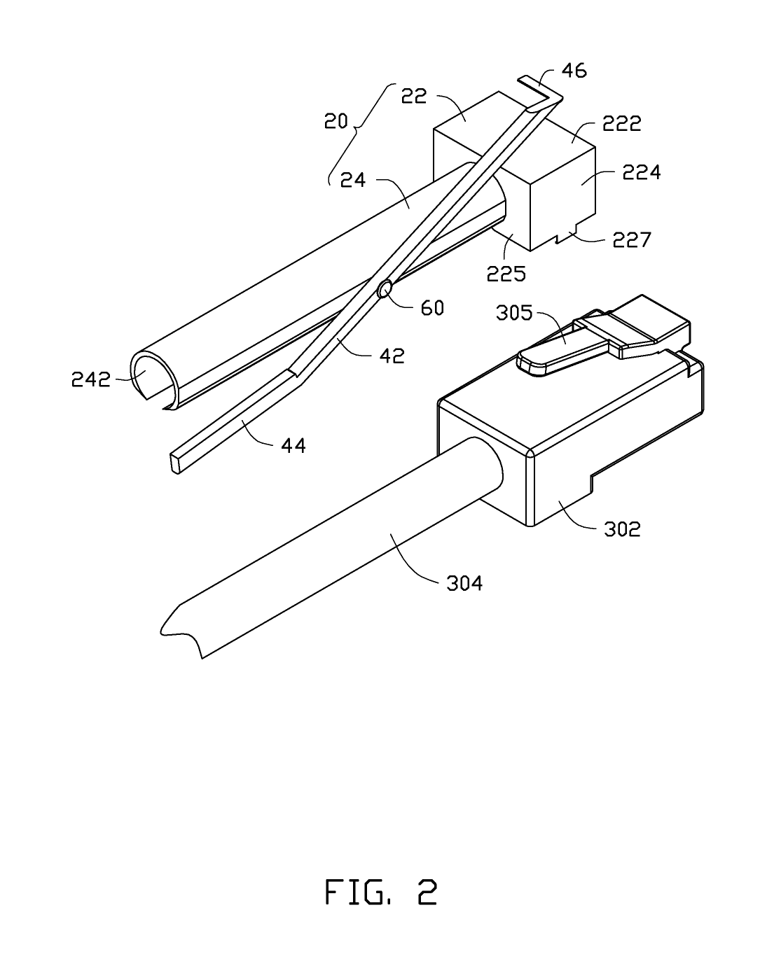

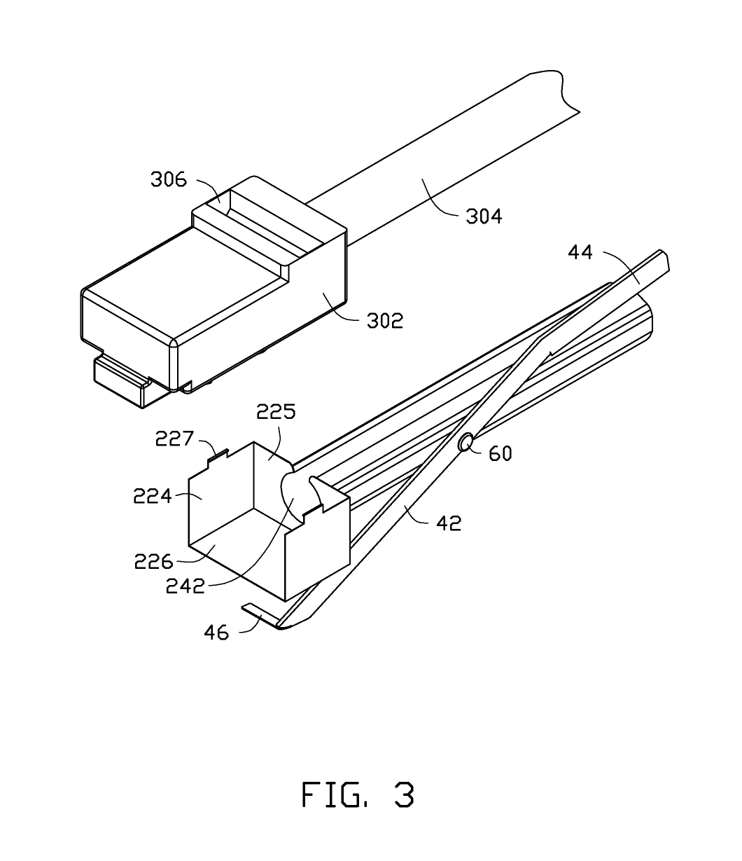

FIGS. 2 and 3 show the plug tool 100 together with the connector 300. The connector 300 includes a plug 302 and a cable 304 electrically connected to the plug 302. A resilient latching piece 305 slantingly extends rearward and up from a front end of a top of the plug 302. A rear end of a bottom of the plug 302 defines a latching slot 306.

The first operation member 20 includes a fastening shell 22 and a sleeve 24 extending rearward from the fastening shell 22. The fastening shell 22 includes a rectangular connecting plate 222, two latching plates 224 perpendicularly extending down from two opposite ends of the connecting plate 222. In addition, a rear plate 225 perpendicularly extending down from a rear side of the connecting plate 222 and perpendicularly connected to rear sides of the latching plates 224. The connecting plate 222, the latching plates 224, and the rear plate 225 cooperatively bound a receiving space 226. Two opposite resilient hooks 227 extend down from bottoms of the latching plates 224. The sleeve 24 is made of resilient material, such as pliable plastic, and the sleeve 24 has a C-shaped cross-section. The sleeve 24 perpendicularly extends rearward from the rear plate 225 of the fastening shell 22; a bottom of the sleeve 24 is open. The sleeve 24 axially defines a receiving slot 242 communicating with the receiving space 226, and extending through a bottom of the rear plate 225.

The second operation member 40 includes a rotating pole 42 rotatably connected to the sleeve 24 with a middle through a shaft 60, a pressing portion 46 perpendicularly extending from a first end of the rotating pole 42 toward the sleeve 24, and an operation pole 44 slantingly extending from a second end of the rotating pole 42 opposite to the pressing portion 46.

To assemble the connector 30 to the plug tool 100, the fastening shell 22 fits about the rear end of the plug 302 through the receiving space 226 from the top of the plug 302. The hooks 227 are latched in the latching slot 306. Thereby, the plug 302 is fastened to the fastening shell 22, with the latching piece 305 locating above the connecting plate 222. A portion of the cable 304 adjacent to the plug 302 is inserted into the receiving slot 242 of the sleeve 24.

To plug the connector 300 into one of the interfaces 502 of the switch 500, the sleeve 24 is gripped by an operator to insert the plug 302 into the interface 502. It is convenient to operate the connector 300, because the operation distance of the connector 300 is increased by using the plug tool 100. Furthermore, because the connector 300 is received in the plug tool 100, the cable 304 does not become loosened from the plug 302.

To unplug the connector 300 from the interface 502 of the switch 500, the operation pole 44 is manually operated to rotate the rotating pole 42 about the shaft 60. The pressing portion 46 moves down to press the latching piece 305 of the connector 300, deforming the latching piece 305, until the latching piece 305 is detached from the interface 502. The connector 300 is easily removed from the switch 500.

In this embodiment, the connector 300 is a serial advanced technology attachment connector.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A plug tool for plugging or unplugging a connector, the plug tool comprising:
a first operation member comprising a fastening shell for receiving a plug of the connector and a sleeve extending out from the fastening shell for receiving a cable of the connector; and
a second operation member rotatably connected to the sleeve, wherein the second operation member comprises a pressing portion for pressing a resilient latching piece extending from the plug of the connector.

2. The plug tool of claim 1, wherein the fastening shell comprises a rectangular connecting plate, two latching plates extending down from two opposite ends of the connecting plate, and a rear plate extending down from a rear side of the connecting plate, the connecting plate, the latching plates, and the rear plate cooperatively bound a receiving space for receiving the plug of the connector.

3. The plug tool of claim 2, wherein the sleeve extends rearward from the rear plate, the sleeve axially defines a receiving slot communicating with the receiving space.

4. The plug tool of claim 3, wherein the receiving slot extends through a bottom of the rear plate.

5. The plug tool of claim 2, wherein two resilient hooks extend down from bottoms of the latching plates for latching a bottom of the plug of the connector.

6. The plug tool of claim 1, wherein the sleeve is made of resilient material.

7. The plug tool of claim 1, wherein the sleeve has a C-shaped cross-section.

8. The plug tool of claim 1, wherein the second operation member further comprises a rotating pole rotatably connected to the sleeve through a shaft, the pressing portion extends from a first end of the rotating pole.

9. The plug tool of claim 7, wherein the second operation member further comprises an operation pole extending rearward from a second end of the rotating pole opposite to the pressing portion.

10. A connector assembly comprising:
a plug;
a resilient latching piece extending rearward and up from a front end of a top of the plug;
a cable connected to a rear end of the plug; and
a plug tool comprising a first operation member and a second operation member rotatably connected to the first operation member, wherein the first operation member comprises a fastening shell receiving the plug and a sleeve extending out from the fastening shell and receiving the cable, the second operation member comprises a pressing portion, and when unplugging the plug, the second operation member rotates relative to the first operation member such that the pressing portion presses the latching piece toward the plug.

11. The connector assembly of claim 10, wherein the fastening shell comprises a rectangular connecting plate, two latching plates extending down from two opposite ends of the connecting plate, and a rear plate extending down from a rear side of the connecting plate, the connecting plate, the latching plates, and the rear plate cooperatively bound a receiving space for receiving the plug of the connector.

12. The connector assembly of claim 11, wherein the sleeve extending rearward from the rear plate, the sleeve axially defines a receiving slot communicating with the receiving space and extending through a bottom of the rear plate.

13. The connector assembly of claim 11, wherein two resilient hooks extend down from bottoms of the latching plates for latching a bottom of the plug.

14. The connector assembly of claim 10, wherein the sleeve has a C-shaped cross-section.

15. The connector assembly of claim 10, wherein the second operation member further comprises a rotating pole rotatably connected to the sleeve through a shaft, the pressing portion extends from a first end of the rotating pole.

16. The connector assembly of claim 15, wherein the second operation member further comprises an operation pole extending rearward from a second end of the rotating pole opposite to the pressing portion.
